(19) United States
(12) Patent Application Publication
(10) Pub. No.: US 2013/0087979 A1
(43) Pub. Date: Apr. 11, 2013

(54) JOINTLESS BRAIDED SEALING RING AS WELL AS METHOD AND SPECIAL MACHINE FOR PRODUCING SUCH SEALING RING

(71) Applicants: Qigao Wen, Nanyang (CN); Qianqian Wen, Nanyang (CN)

(72) Inventors: Qigao Wen, Nanyang (CN); Qianqian Wen, Nanyang (CN)

(73) Assignee: XIXIAXIAN JINFANGYUAN SEALING MATERIAL CO., LTD., Nanyang, Henan (CN)

(21) Appl. No.: 13/805,848

(22) PCT Filed: Jul. 17, 2010
(86) PCT No.: PCT/CN10/75225

§ 371 Date: Dec. 20, 2012

(30) Foreign Application Priority Data
Jun. 23, 2010 (CN) 201010207282.4

(51) Int. Cl. F16J 15/34

(52) U.S. Cl. CPC F16J 15/34
USPC 277/500; 87/8

(57) ABSTRACT

A jointless braided sealing ring as well as a method and a special machine for producing such a sealing ring are disclosed. The braided sealing ring adopts a multi-layers braided structure comprising a number of continuously sleeved ring layers arranged from inside to outside. The innermost braided ring layer is used as a core. The tail end of the first braided ring layer (1) is sleeved on the starting end of the first braided ring layer (1) and serves as the starting end of the second braided ring layer (2) to implement continuously braiding without any interruption. The second braided ring layer (2) is sleeved on the first braided ring layer (1) and the third braided ring layer (3) is sleeved on the second braided ring layer (2). The Nth braided ring layer (4) is sleeved on the (N−1)th braided ring layer (5). N braided ring layers have (N−1) continuous intact braided ring layers. The tail end (8) of the outermost braided ring layer is superposed with the starting end (7) of the innermost braided ring layer. Service life and sealing effect of the braided sealing ring are increased. A perimeter-defining ring (6) is provided in the sealing ring to improve the dimensions precision of sealing ring, and avoid that the sealing ring deforms during braiding and trimming.

### FIELD OF THE INVENTION

The present invention relates to the braided sealing ring technical field, in particular to an jointless braided sealing ring, its production method, and special equipment.

### BACKGROUND OF THE INVENTION

In the sealing material industry, the braided sealing material is widely applied to various technical fields. The common seal materials include aramid, polytetrafluoroethylene, polyimide, carbon fibers, flexible graphite, ramie and so on. The range of applications involves sealing parts with a round, square, oval, and a variety of polygons closed surface. Especially in some particularly important seal place which involves significant safety under high temperature and high pressure environment, braided sealed ring play a more important role. Under normal circumstances, when the braided seals, a circular knitting machine or a square-knitting machine is usually used first according to the need of the sealing, the sealing fibers are braided into a certain diameter of the rope-like fibrous structure, and then upon request, strand-like sealing material are cut into a section of the length unit, then the starting and end of this length unit are both connected to form a closed ring body, i.e. seal. Several common ring, such as monolayer lap, double lap, sockets are formed, and each joint approach of which are required to joint to the overall shape of the seal ring, performance impact as small as possible, but one unavoidable problem is that no matter how improved, the methods and techniques of its joint is always the weakest link in the structure of the entire sealing ring in terms of strength, and other parts of the joint is always apparent inconsistency of the sealing performance in structure, which affects sealing properties and its service life. Especially in large power equipment, high-temperature melting and continuous production line, nuclear facilities, spacecraft, large vessels, heavy industrial equipment, high precise, advanced field, high temperature, high pressure, strong wear, strong corrosion site appear due to the sealing material. The problems arising from the discontinuation, downtime, outage, and the replacement of the seals will not only prompt equipment manufacturers to suffer from a significant loss, the impact of large-scale projects run also lead to serious malignant safety accidents.

### SUMMARY OF THE INVENTION

The present invention provides a jointless braided sealing ring with a greatly improved life and improved sealing performance, its production method and special equipment.

A jointless braided sealing ring is provided, which adopts a multi-layers braided structure comprising a number of continuously sleeved ring layers arranged from inside to outside in its section, wherein the first braided ring layer is used as a base layer, the tail end of the first braided ring layer is sleeved on the starting end of the first braided ring layer and serves as the starting end of the second braided ring layer to implement continuously braiding without any interruption, the tail end of the second braided ring layer is sleeved on the starting end of the second braided ring layer and serves as the starting end of the third braided ring layer, the third braided ring layer is sleeved on the second braided ring layer, . . . , and the resulting Nth braided ring layer is sleeved on the (N−1)th braided ring layer.

The tail end of the outermost braided ring layer is superposed with the starting end of the innermost braided ring layer.

A circle for defining the circumference of ring body is provided within the braided sealing ring.

A method for producing a jointless braided sealing ring is provided, which comprises the following steps:

a. a circle for defining the circumference of ring body is sleeved on the braiding area of a special equipment, the starting end of the braided fiber is fixed on the circle for defining the circumference of ring body based on the circle for defining the circumference of ring body, and start to braid in a form of sleeving;

b. a device for fixing braided fiber bodies is removed prior to the completion of the first braided ring layer;

c. after the first braided ring layer braiding is completed, subsequent braided ring layer is sleeved on the starting end of the first braided ring layer, to start the braiding of the second braided ring layer;

d. after the completion of the second braided ring, the third braided ring layer is sleeved on the second braided ring layer, . . . , after the completion of the (N−1)th braided ring, the resulting Nth braided ring layer is sleeved on the (N−1)th braided ring layer;

e. the sealing ring is removed from the special equipment until the number of the braided ring layers meets the requirements, and is trimmed and packaged as desired, to complete the production of the braided sealing ring.

A special equipment for producing a jointless braided sealing ring is provided, which comprises a rack, a power mechanism, a transmission mechanism, a braiding spindle, a braiding track, a spindle movement mechanism, and a braiding density adjustment mechanism, wherein the power mechanism is connected to the spindle moving mechanism through the transmission mechanism, the braiding spindle is provided within the braiding track, the lower end of this braiding spindle is connected to the spindle moving mechanism, and a opening is disposed across the inside and outside of the track.

The opening disposed across the inside and outside of the track comprises a removable block and a rail body connection mechanism.

The novel jointless braided sealing ring of this invention adopts a multi-layers braided structure comprising a number of continuously sleeved ring layers arranged from inside to outside in its section, wherein the first braided ring layer is used as the core of the ring, the tail end of the first braided ring layer is sleeved on the starting end of the first braided ring layer and serves as the starting end of the second braided ring layer to implement continuously braiding without any interruption, the tail end of the second braided ring layer is sleeved on the starting end of the second braided ring layer and serves as the starting end of the third braided ring layer, the third braided ring layer is sleeved on the second braided ring layer, . . . , and the resulting Nth braided ring layer is sleeved on the (N−1)th braided ring layer. The N braided ring layers have (N−1) continuous and integral braided ring layers, and the tail end of the outermost braided ring layer is superposed with the starting end of the innermost braided ring layer. The aspects mentioned above substantially eliminate the various problems resulting from joints, and effectively improve the knitting of the service life of the seal ring and sealing effect. The provision of defining ring within the sealing ring ensure the machining seal ring dimensional to be accuracy, solve the technical difficulties in the knitting and shaping process, and the problem that seal ring is easily deformed. Setting of the opening disposed across the inside and outside of the track allow the placement of the circle for defining the circumference of ring body convenient in a removable manner. After the placement, a detachable block can be mounted to complete assembling and use of the machine, while braided seal ring can be also easily removed after the completion of the processing.

### BRIEF DESCRIPTION OF THE DRAWINGS

In the following, the present invention will be further described in conjunction with the accompanying drawings:

FIG. 1 is a sectional schematic structural view of the jointless braided sealing ring according to the present invention;

FIG. 2 is a schematic structural view of the jointless braided sealing ring according to the present invention along its horizontal section;

FIG. 3 is an enlarged view of a connecting portion without interruption of the jointless braided sealing ring according to the present invention;

FIG. 4 is a schematic block diagram of special equipment for producing the jointless braided sealing ring according to the present invention.

### DETAILED DESCRIPTION OF THE INVENTION

### Embodiment 1

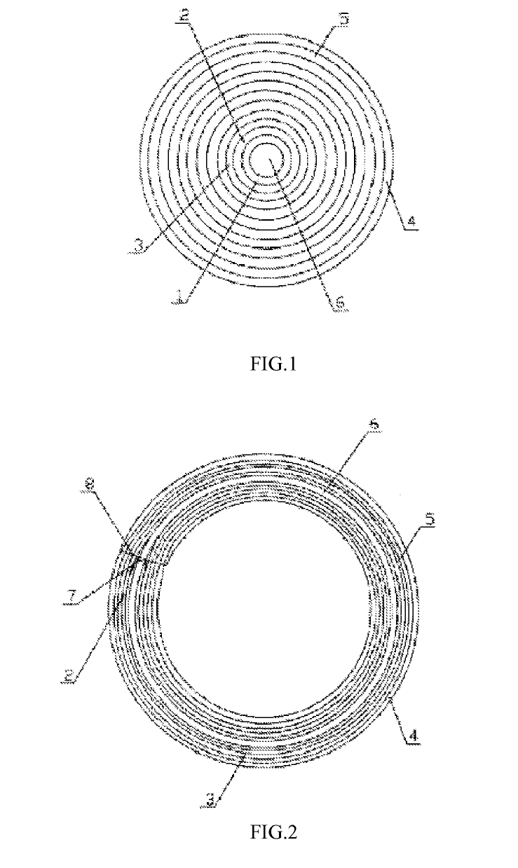

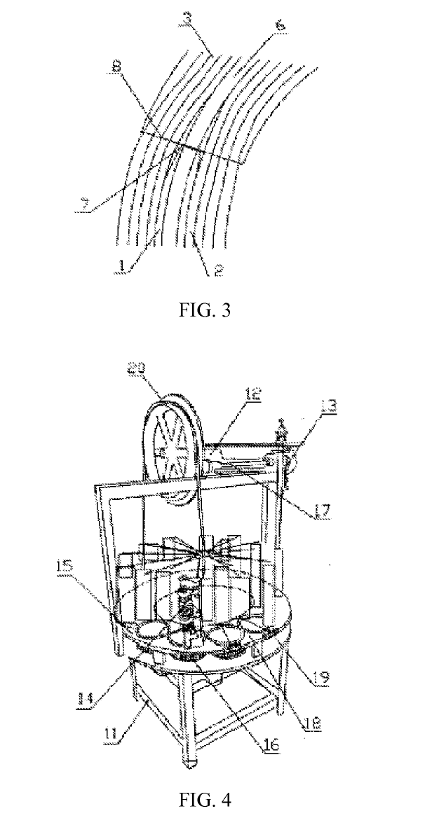

As shown in FIGS. 1, 2, and 3, a jointless braided sealing ring is provided, which adopts multi-layers braided structure comprising a number of continuously sleeved ring layers arranged from inside to outside in its section, wherein the first braided ring layer 1 is used as a base layer, the tail end of the first braided ring layer 1 is sleeved on the starting end of the first braided ring layer 1 and serves as the starting end of the second braided ring layer 2 to implement continuously braiding without any interruption, the tail end of the second braided ring layer 2 is sleeved on the starting end of the second braided ring layer 2 and serves as the starting end of the third braided ring layer 3, the third braided ring layer 3 is sleeved on the second braided ring layer 2, . . . , and the Nth braided ring layer 4 is sleeved on the (N−1)th braided ring layer 5. Nth braided ring layer is the outermost layer, and n is a positive integer.

The tail end 8 of the Nth braided ring layer 4 is superposed with the starting end 7 of the first braided ring layer, that is, the outermost braided ring layer is superposed with the starting end of the innermost braided ring layer. This superposition can allow the braided seal ring generated to have a more uniform and reasonable shape, better performance, greater reliability, and longer life.

A circle 6 for defining the circumference of ring body is provided within the braided sealing ring. The length of the circle for defining the circumference of ring body depends on the circumference of the braided sealing ring and the material of which may be metal or metalloid less prone to deformation, such as wires welded into the ring.

### Embodiment 2

As shown in FIGS. 1, 2, and 3, a jointless braided sealing ring is provided, which adopts multi-layers braided structure comprising a number of continuously sleeved ring layers arranged from inside to outside in its section, wherein the a circle 6 for defining the circumference of ring body provided within the braided sealing ring is used as a base layer, the tail end of the first braided ring layer 1 is sleeved on the starting end of the first braided ring layer 1 and serves as the starting end of the second braided ring layer 2 to implement continuously braiding without any interruption, the tail end of the second braided ring layer 2 is sleeved on the starting end of the second braided ring layer 1 and serves as the starting end of the third braided ring layer 3, the third braided ring layer 3 is sleeved on the second braided ring layer 2, . . . , and the Nth braided ring layer 4 is sleeved on the (N−1)th braided ring layer 5. The Nth braided ring layer 4 is the outermost layer, and n is a positive integer.

The tail end 8 of the Nth braided ring layer 4 is superposed with the starting end 7 of the first braided ring layer, that is, the outermost braided ring layer is superposed with the starting end of the innermost braided ring layer. This superposition can allow resulting the braided seal ring to have a more uniform and reasonable shape, better performance, greater reliability, and longer life.

As shown in FIGS. 1, 2, and 3, a method for producing a jointless braided sealing ring is provided, which comprises the following steps:

a. a opening in the special equipment for producing a jointless braided sealing ring is opened, that is, a removable block 18 is removed, and a circle 6 for defining the circumference of ring body is sleeved on the braiding area 20 of special equipment, a removable block 19 is installed, the starting end of the braided fiber is fixed on the circle 6 for defining the circumference of ring body based on the circle 6 for defining the circumference of ring body, and start to braid in a form of sleeving;

b. a device for fixing braided fiber is removed prior to the completion of the first braided ring layer 1, i.e. during the braiding of the first braided ring layer, and start to braid the second braided ring layer 2. In practice, a section of the fiber can be cut out;

c. after the first braided ring layer braiding is completed, subsequent braided ring layer 3 is sleeved on the starting end of the first braided ring layer 1, to start the braiding of the second braided ring layer.

d. after the completion of the second braided ring layer 2, the third braided ring layer 3 is sleeved on the second braided ring layer 2, . . . , after the completion of the (N−1)th braided ring layer 5, the Nth braided ring layer 4 is sleeved on the (N−1)th braided ring layer 5;

e. the sealing ring is removed from the special equipment through opening the removable block 18 on the special equipment until the number of the braided ring layers meets the requirements. The jointless braided sealing ring which can be used without trimming is packaged as a finished product directly. The jointless braided sealing ring required for trimming as desired is trimmed and packaged to complete the production of braided sealing ring.

As shown in in FIG. 4, a special equipment for producing a jointless braided sealing ring is provided, which comprises a rack 12, a power mechanism 12, a transmission mechanism 13, a braiding spindle 14, a braiding track 15, a spindle movement mechanism 16, a braiding density adjustment mechanism 17, wherein the power mechanism 12 is connected to the spindle moving mechanism 16 through the transmission mechanism 13, the braiding spindle 14 is provided within the braiding track 15, the lower end of this braiding spindle is connected to the spindle moving mechanism 16, and a opening is disposed across the inside and outside of the track 15.

Said opening is disposed across the inside and outside of the track 15 includes a removable block 18 and a rail body connecting mechanism 19. Removable block 18 and rail body connecting mechanism 19 are used conjointly to remove or install removable block 18, and this removing facilitates the circle 6 for defining the circumference of ring body to be installed the circumference of the ring body is limited circle 6 subsequently. The jointless ring is removed at the end. The installation of the removable block 18 can ensure that the entire machine is working properly.

The jointless braided sealing ring of this invention adopts a multi-layers braided structure comprising a number of continuously sleeved ring layers arranged from inside to outside in its section, wherein the first braided ring layer is used as the core of the ring, the tail end of the first braided ring layer is sleeved on the starting end of the first braided ring layer and serves as the starting end of the second braided ring layer to implement continuously braiding without any interruption, the tail end of the second braided ring layer is sleeved on the starting end of the second braided ring layer and serves as the starting end of the third braided ring layer, the third braided ring layer is sleeved on the second braided ring layer, . . . , and the resulting Nth braided ring layer is sleeved on the (N−1)th braided ring layer. The N braided ring layers have (N−1) continuous and integral braided ring layers, and the tail end of the outermost braided ring layer is superposed with the starting end of the innermost braided ring layer. The aspects mentioned above substantially eliminate the various problems resulting from joints, and effectively improve the knitting of the service life of the seal ring and sealing effect. The provision of defining ring within the sealing ring ensure the machining seal ring dimensional to be accuracy, solve the technical difficulties in the knitting and shaping process, and the problem that seal ring is easily deformed. Setting of such opening disposed across the inside and outside of the track allow for the placement of the circle for defining the circumference of ring body conveniently in a removable manner. After the placement, a detachable block can be mounted to complete assembling and use of the machine, while braided seal ring can be also easily removed after the completion of the processing.

What is claimed is:

1. A jointless braided sealing ring, which adopts a multi-layers braided structure comprising a number of continuously sleeved ring layers arranged from inside to outside in its section, wherein the first braided ring layer is used as a base layer, the tail end of the first braided ring layer is sleeved on the starting end of the first braided ring layer and serves as the starting end of the second braided ring layer to implement continuously braiding without any interruption, the continuously braided second braided ring layer is sleeved on the first braided ring layer, the tail end of the second braided ring layer is sleeved on the starting end of the second braided ring layer and serves as the starting end of the third braided ring layer, the third braided ring layer is sleeved on the second braided ring layer, . . . , and the Nth braided ring layer (4) is sleeved on the (N−1)th braided ring layer.

2. A jointless braided sealing ring as claimed in claim 1, wherein the tail end of the outermost braided ring layer is superposed with the starting end of the innermost braided ring layer.

3. A jointless braided sealing ring as claimed in claim 2, wherein a circle for defining the circumference of ring body is provided within the braided sealing ring.

4. A method for producing a jointless braided sealing ring, which comprises the following steps:
a. a circle for defining the circumference of ring body is sleeved on the braiding area of a special equipment, the starting end of the braided fiber is fixed on the circle for defining the circumference of ring body based on the circle for defining the circumference of ring body, and start to braid in a form of sleeving;
b. a device for fixing braided fiber bodies is removed prior to the completion of the first braided ring layer;
c. after the first braided ring layer braiding is completed, subsequent braided ring layer is sleeved on the starting end of the first braided ring layer, to start the braiding of the second braided ring layer;
d. after the completion of the second braided ring, the third braided ring layer is sleeved on the second braided ring layer, . . . , after the completion of the (N−1)th braided ring, the resulting Nth braided ring layer is sleeved on the (N−1)th braided ring layer;
e. the sealing ring is removed from the special equipment until the number of the braided ring layers meets the requirements, and is trimmed and packaged as desired, to complete the production of the braided sealing ring.

5. A special equipment for producing a jointless braided sealing ring, which comprises a rack, a power mechanism, a transmission mechanism, a braiding spindle, a braiding track, a spindle movement mechanism, and a braiding density adjustment mechanism, wherein the power mechanism is connected to the spindle moving mechanism through the transmission mechanism, the braiding spindle is provided within the braiding track, the lower end of this braiding spindle is connected to the spindle moving mechanism, and a opening is disposed across the inside and outside of the track.

6. A special equipment for producing a jointless braided sealing ring as claimed in claim 5, wherein the opening disposed across the inside and outside of the track comprises a removable block and a rail body connection mechanism.
